(19) United States
(12) Patent Application Publication
(10) Pub. No.: US 2010/0143771 A1
(43) Pub. Date: Jun. 10, 2010

(54) Rotatable Battery Pack

(75) Inventors: Ji-young JEONG, Yongin-si (KR); Meen-seon Paik, Yongin-si (KR); Tae-sang Park, Yongin-si (KR); Tae-won Song, Yongin-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/615,406

(22) Filed: Nov. 10, 2009

(30) Foreign Application Priority Data
Dec. 8, 2008 (KR) 10-2008-0124292

(51) Int. Cl. H01M 10/50

(52) U.S. Cl. 429/62; 429/120

(57) ABSTRACT

A rotatable battery pack having a first electrode plate and a second electrode plate disposed in parallel to each other and allowing a plurality of battery cells to be disposed between the first electrode plate and the second electrode plate; a casing enclosing the first electrode plate and the second electrode plate and having both ends opened so as to allow cooling air to flow in order to cool the plurality of battery cells; a first terminal protruding from a center of the first electrode plate to an outside of the casing; a second terminal protruding from a center of the second electrode plate to the outside of the casing in a direction opposite that of the first electrode; and a driving motor driving the first electrode plate to rotate the plurality of battery cells, wherein the first terminal and the second terminal are formed on a rotation axis of the first electrode plate.

### CROSS-REFERENCE TO RELATED APPLICATIONS

This application claims the benefit of Korean Patent Application No. 10-2008-0124292, filed Dec. 8, 2008, in the Korean Intellectual Property Office, the disclosure of which is incorporated herein by reference.

### BACKGROUND OF THE INVENTION

1. Field of the Invention

Aspects of the present invention relate to a rotatable battery pack, and more particularly, to a battery pack that may reduce a temperature difference among battery cells in a casing by rotating the battery cells in the casing.

2. Description of the Related Art

Battery packs include a casing enclosing a plurality of battery cells. Battery cells used in hybrid cars or electric cars are mainly lithium (Li)-ion battery cells with a higher energy density than that of nickel metal hydride (Ni-MH) battery cells.

Battery cells in a battery pack independently cause electrochemical reactions and generate electricity, creating heat as a by-product. In general, a cooling device for the battery pack supplies cooling air into an inlet of a casing, and the cooling air discharges through an outlet of the casing. The temperature of such cooling air increases toward the outlet as a result of heat exchange. Thus, a temperature difference inside the casing may reduce the performance and the lifetime of the battery pack.

### SUMMARY OF THE INVENTION

Aspects of the present invention provide a rotatable battery pack that can reduce a temperature difference in a casing.

Aspects of the present invention provide a rotatable battery pack including a first electrode plate and a second electrode plate disposed in parallel to each other and allowing a plurality of battery cells to be disposed between the first electrode plate and the second electrode plate; a casing enclosing the first electrode plate and the second electrode plate and having both ends opened so as to allow cooling air to flow in order to cool the plurality of battery cells; a first terminal protruding from the center of the first electrode plate to the outside of the casing; a second terminal protruding from the center of the second electrode plate to the outside of the casing in a direction opposite that of the first electrode; and a driving motor driving the first electrode plate to rotate the plurality of battery cells, wherein the first terminal and the second terminal are formed on a rotation axis of the first electrode plate.

According to another aspect of the present invention, the rotatable battery pack may further comprise fixing members for supporting the first terminal and the second terminal to be rotated.

According to another aspect of the present invention, the fixing members may be bushings or bearings.

According to another aspect of the present invention, the rotatable battery pack may further comprise a first electrode and a second electrode electrically connected to the first terminal and the second terminal, respectively, to supply electricity to a load.

According to another aspect of the present invention, the first electrode and the second electrode may be springs elastically biased to the first terminal and the second terminal, respectively.

According to another aspect of the present invention, the first electrode and the second electrode may be brushes elastically biased to the first terminal and the second terminal, respectively.

According to another aspect of the present invention, the rotatable battery pack may further comprise a reducer gear connecting the driving motor and the first terminal.

According to another aspect of the present invention, an inlet of the casing through which the cooling air is introduced may have a cross-sectional area that is greater than that of an outlet of the casing through which the cooling air is discharged.

According to another aspect of the present invention, the rotatable battery pack may further include a lower plate installed under the first electrode plate and supporting the first electrode plate; an upper plate installed over the second electrode plate and supporting the second electrode plate; and a plurality of spacers disposed between the lower plate and the upper plate and fixedly connecting the lower plate and the upper plate.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view of a rotatable battery pack according to an embodiment of the present invention; and

FIG. 2 is a partial cross-sectional view of the rotatable battery pack of FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

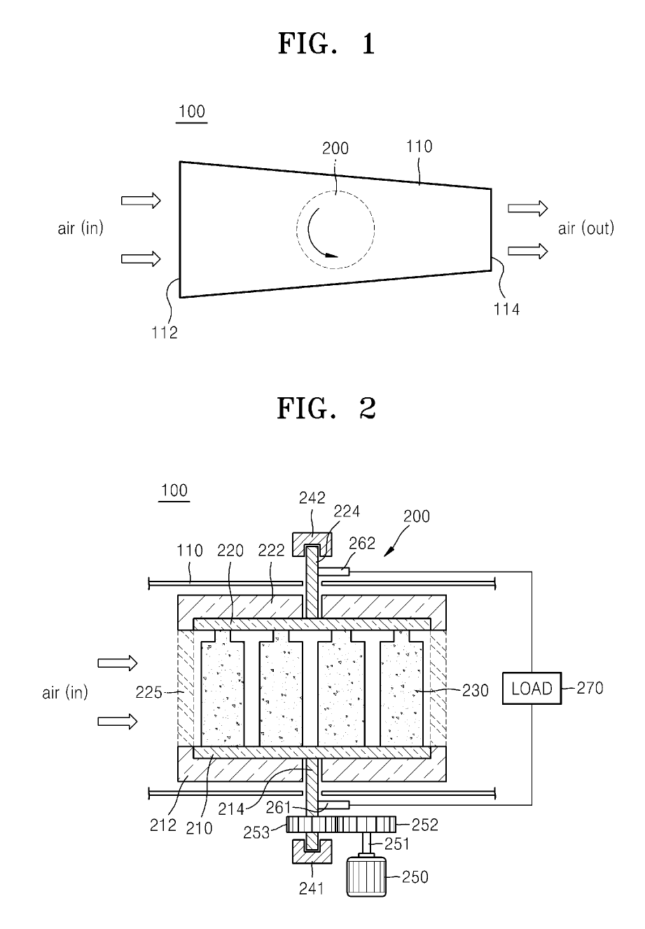

The thicknesses of layers or regions shown in FIGS. 1 and 2 are exaggerated for clarity.

FIG. 1 is a plan view of a rotatable battery pack 100 according to an embodiment of the present invention.

The rotatable battery pack 100 is installed beneath a seat on an electric car, and is cooled by cooling air introduced as the electric car moves forward. The rotatable battery pack 100 may include a casing 110 guiding the cooling air. The casing 110 has an inlet 112 and an outlet 114 respectively through which the cooling air is introduced and discharged. The inlet 112 may have a cross-sectional area greater than that of the outlet 114 in order to draw a draft and improve cooling efficiency. A rotating unit 200, in which a plurality of battery cells 230 (see FIG. 2) are installed, is disposed in the casing 110.

FIG. 2 is a partial cross-sectional view of the battery pack 100 of FIG. 1. Referring to FIG. 2, the battery pack 100 includes a casing 110 and a rotating unit 200. The rotating unit 200 includes a first electrode plate 210 and a second electrode plate 220 which are installed in parallel to each other and are spaced apart from each other at a predetermined distance. Either the first electrode plate 210 or the second electrode plate 220 is an anode plate and the remaining one of the two is a cathode plate. The plurality of battery cells 230 are disposed between the first electrode plate 210 and the second electrode plate 220. A lower plate 212 may be further disposed under the first electrode plate 210, and an upper plate 222 may be further disposed over the second electrode plate 220. The upper plate 222 and the lower plate 212 are connected to each other by spacers 224. The upper plate 222 and the lower plate 212 are spaced apart from each other due to the spacers 224. The spacers 224 transmit a rotating force of the lower plate 212 to the upper plate 222. The upper plate 222 and the lower plate 212 may be formed of a non-conductive material, for example, plastic.

The plurality of battery cells 230 are connected to the first electrode plate 210 and the second electrode plate 220 in parallel.

A first terminal 214 is formed at the center of the first electrode plate 210 to protrude from the lower plate 212 and the casing 110 in a direction exterior to the casing 110. A second terminal 224 is formed at the center of the second electrode plate 220 to protrude from the upper plate 222 and the casing 110 in a direction opposite of the first terminal. The first terminal 214 and the second terminal 224 are formed on the rotation axis of the first electrode plate 210 and the second electrode plate 220.

A bushing 241 for supporting the rotatable first terminal 214 is fitted around an end of the first terminal 214. Another bushing 242 for supporting the rotatable second terminal 224 is fitted around an end of the second terminal 224. A ball bearing (not shown) or a roller bearing (not shown) may be used as a fixing member instead of the bushing 241 and 242.

A driving motor 250 rotating the first electrode plate 210 and the second electrode plate 220 is connected to the first terminal 214. A first gear 252 is installed on a shaft 251 of the driving motor 250, and a second gear 253 is installed on the first terminal 214. The first gear 252 and the second gear 253 are engaged with each other such that the first terminal 214 is rotated when the driving motor 250 is rotated. The first gear 252 has a diameter greater than that of the second gear 254 in order to reduce the rotational speed of the first terminal 214. The first gear 252 and the second gear 254 constitute a reducer gear.

A first electrode 261 and a second electrode 262 are respectively installed on outer peripheral surfaces of the first terminal 214 and the second terminal 224 in order to be electrically connected to the first terminal 214 and the second terminal 224 while the first terminal 214 and the second terminal 224 are rotated. The first electrode 261 and the second electrode 262 may be springs or brushes elastically biased to the first terminal 214 and the second terminal 224, respectively. The first electrode 261 and the second electrode 262 are connected to a load 270. The load 270 may be an engine of the electric car. Although not shown in FIG. 2, a direct current (DC) voltage booster and a power controller may be further installed between the electrodes 261 and 262 and the load 270, and a detailed explanation thereof will be omitted.

The operation of the rotatable battery pack 100 will now be explained with reference to FIGS. 1 and 2.

The inlet 112 of the casing 110 is formed in a front portion of the electric car and the outlet 114 is formed in a rear portion of the electric car. As the electric car moves forward, cooling air is introduced into the casing 110 through the inlet 112 to cool heat generated by the battery cells 230, and then is discharged to the outside of the casing 110 through the outlet 114. When the temperature of the outlet 114 is increased above a predetermined temperature, the driving motor 250 is rotated. Accordingly, since the temperatures of the battery cells 230 are maintained similar to one another, a temperature difference in the battery cells 230 may be reduced, and thus the performance of the rotatable battery pack 100 may be improved.

As described above, a rotatable battery pack according to the one or more of the above embodiments may reduce a temperature difference in the battery cells, the performance of the rotatable battery pack may be improved, and the lifetime of the rotatable battery pack may be extended.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A rotatable battery pack comprising:
a first electrode plate and a second electrode plate disposed in parallel to each other and allowing a plurality of battery cells to be disposed between the first electrode plate and the second electrode plate;
a casing enclosing the first electrode plate and the second electrode plate and having both ends opened so as to allow cooling air to flow in order to cool the plurality of battery cells;
a first terminal protruding from a center of the first electrode plate to an outside of the casing;
a second terminal protruding from a center of the second electrode plate to the outside of the casing in a direction opposite that of the first electrode; and
a driving motor driving the first electrode plate to rotate the plurality of battery cells,
wherein the first terminal and the second terminal are formed on a rotation axis of the first electrode plate.

2. The rotatable battery pack of claim 1, further comprising fixing members supporting the first terminal and the second terminal to be rotated.

3. The rotatable battery pack of claim 2, wherein the fixing members are bushings or bearings.

4. The rotatable battery pack of claim 2, further comprising a first electrode and a second electrode electrically connected to the first terminal and the second terminal, respectively, to supply electricity to a load.

5. The rotatable battery pack of claim 4, wherein the first electrode and the second electrode are springs elastically biased to the first terminal and the second terminal, respectively.

6. The rotatable battery pack of claim 4, wherein the first electrode and the second electrode are brushes elastically biased to the first terminal and the second terminal, respectively.

7. The rotatable battery pack of claim 1, further comprising a reducer gear connecting the driving motor and the first terminal.

8. The rotatable battery pack of claim 1, wherein an inlet of the casing, through which the cooling air is introduced, has a cross-sectional area that is greater than that of an outlet of the casing through which the cooling air is discharged.

9. The rotatable battery pack of claim 1, further comprising:
a lower plate installed under the first electrode plate and supporting the first electrode plate;
an upper plate installed over the second electrode plate and supporting the second electrode plate; and
a plurality of spacers disposed between the lower plate and the upper plate and fixedly connecting the lower plate and the upper plate.

10. A method of rotating a battery pack surrounded by a casing having an inlet and an outlet, the method comprising:
inletting air into the casing through the inlet to cool the battery pack;
discharging air out of the casing through the outlet;
determining an outlet temperature of the outlet discharging the air; and
rotating the battery pack if determined that the outlet temperature is above a predetermined temperature.

11. The method of claim 10, wherein the rotating of the battery pack comprises rotating a driving motor rotating the battery pack.

12. The method of claim 11, further comprising maintaining temperatures of a battery cells disposed in the battery pack so that the temperatures of the battery cells are maintained to be similar to each other.
